(19) United States
(12) Patent Application Publication
(10) Pub. No.: US 2006/0031386 A1
(43) Pub. Date: Feb. 9, 2006

(54) System for sharing ontology information in a peer-to-peer network

(75) Inventor: Stephen Lee Burbeck, Carolina Beach, NC (US)

Correspondence Address: HOFFMAN WARNICK & D'ALESSANDRO, LLC, 75 STATE STREET, 14TH FL, ALBANY, NY, 12207, US

(73) Assignee: International Business Machines Corporation, Armonk, NY (US)

(21) Appl. No.: 10/859,283

(22) Filed: Jun. 2, 2004

(51) Int. Cl. G06F 15/16

(52) U.S. Cl. 709/217

(57) ABSTRACT

A system and program product for sharing ontology information in a computer network. The system comprises a peer-to-peer file sharing system that is implemented by a plurality of clients within a network, wherein each client includes: a file sharing system that allows each client to access files from other clients in the network; and an ontology sharing system that allows each client to access ontology information from other clients in the network.

### BACKGROUND OF THE INVENTION

1. Technical Field

The present invention relates generally to data sharing in a peer-to-peer network, and more specifically relates to a system and method for sharing ontology information in a peer-to-peer network.

2. Related Art

In biological sciences the rapid growth of new information is unprecedented. Biologists are inundated by new DNA and protein sequences, new information about the structure or function of these sequences, new information about gene transcription under various conditions, new information about pairwise relationships between genes or proteins, and new discoveries about more complex relationships such as pathways, modules, protein assemblies, organelles, cell signaling, cytoskeletal interactions, etc. The acceleration of new results is in part due to recent advances in high-throughput biology and in part due to advances in bioinformatics, which speeds the digestion and analysis of all this new information. New data and analyses, in turn, fuel new discoveries about how all the various biological entities fit and function together to form living systems.

To keep up with this flood of new data and analyses, scientists must search out, read and understand the new results most relevant to their work. And, to be effective contributors in their field, they must disseminate their own results quickly in ways that others can easily find, read and understand. This interchange of data, analysis and publications depends upon shared agreement about ontologies, that is, shared agreement about what is being studied and how it relates to the many other areas of study that are interdependent.

Previously, searching for relevant information was a matter of following bibliographic references, searching library card catalogs and word-of-mouth pointers. Today, bibliographic references are often active Web links. Card catalogs are replaced by search commands in the various databases and Web search engines such as GOOGLE™. Dissemination used to be primarily by scientific journals but that has become too slow and cumbersome for high-throughput biology. Publication of data has been largely replaced by submission of the data to public databases, publication in e-journals, sharing with a circle of colleagues by email, and publishing on Web pages.

A relatively new phenomenon, peer-to-peer (P2P) file sharing, has some advantages over more centralized systems for both dissemination and search. P2P can provide more rapid dissemination of files and allows searching of the very latest available data and papers without waiting for a search engine crawler to visit a site. Perhaps more importantly, P2P networks can be specialized for a given purpose.

Dissemination and search in a P2P network can proceed in a haphazard manner, but is more effective if there is some organization of concepts and topics to guide the searcher. That is, search and dissemination are more effective if they take place in the context of one or more ontologies. Ontologies are webs of interrelated names and concepts used to organize and standardize human knowledge. In the special case where the concepts can be organized into a hierarchy, i.e., a tree structure, ontologies are called taxonomies. In the human domain, ontologies are informal and ever changing. Individuals and cultures evolve ontologies as part of learning languages and participating in social discourse. Everyone makes his or her own personal ontologies. They then share information about how they organize knowledge by their everyday discourse. However, databases require more formal rigid organization

A number of projects are attempting to develop formal ontologies for biological science, e.g., the Gene Ontology Consortium. Current approaches include utilizing domain experts and ‘knowledge engineers’ working in close collaboration to either create ontologies, or have them derived semi-automatically from databases and natural language sources. However, many ontologies are required to deal with the many goals of different types of research. In fields such as biology where information is proliferating, no reasonably small number of standard ontologies exists to satisfy the needs of all researchers. Simply generating a consensus about the meaning of various terms is a challenge in itself.

The problem is evident even in a far less rapidly changing area, such as geography. Places have different names in different languages, or simple alternate names, not to mention slang names (The Big Apple). Areas change from one nation to another and nations dissolve. The same name can be used for more than one place, e.g., New York (City or State) or Santa Clara (City or County). In some cases cities are identical to counties (Los Angeles). Some modern patchwork cities contain unincorporated areas that are in the county but surrounded by the city. Names and boundaries differ at different times (Ancient Rome vs. modern Rome).

Biologists face many similar problems. The same gene or protein may have multiple names within one species and still other names in other species. The familiar taxonomy of species most of us learned in introductory high school biology turns out to be at best an approximation. The notion that DNA is contained in chromosomes within the nucleus of eukaryotes turns out to be an oversimplification (there is DNA in mitochondria as well). The notion that a gene codes for a protein turns out to be oversimplified too. In humans, for example, a single gene may produce hundreds of different alternate splice variants. Knowledge about the functions of proteins is rapidly changing and the same protein may have different functions in different cell types. The notion that cells operate as individual units is too simplistic as well. Hepatocytes (liver cells), for example, are joined together by pores between cells that let many molecules move between cells. Tissues are made up of an extracellular matrix that is created by and in turn guides the formation of cells. And so forth.

Most other disciplines—sciences, history, literature, law, medicine, and the arts—have similar complexities that frustrate attempts to define rigorous and unchanging ontologies. Decades of study of knowledge representation (not to mention centuries of scientific taxonomy experience) shows that it is not possible to provide one taxonomy suitable for all. Scientists do not view their field in identical ways and can disagree in very fundamental ways about how to organize the knowledge in their field.

Despite all the above difficulties, people create and use ontologies, usually without much awareness of the ambiguities. Biological scientists merrily discover and name genes much the way 18th and 19th century European explorers named mountains, rivers, lakes, and even peoples. Humans tend to deal with the problem in an ad hoc peer-to-peer manner by consensus and word-of-mouth. When humans explore and discover new territory, whether geographical or conceptual, a rich, complex and changing set of names and relationships between names emerges. Placing them into an agreed-upon well-defined ontology that organizes all the important distinctions is incredibly difficult if not impossible. To expect such an ontology, once done, to remain unchanged is completely unrealistic. Instead, humans use ad hoc informal ontologies that are updated constantly by frequent discussion, debate, etc. Accordingly, a need exists for better methodology of creating, managing, and updating computerized ontologies.

### SUMMARY OF THE INVENTION

The present invention addresses the above-mentioned problems, as well as others, by providing a system and program product for sharing and managing ontology information in a peer-to-peer network. In a first aspect, the invention provides a peer-to-peer file sharing system that is implemented by a plurality of clients within a network, wherein each client includes: a file sharing system that allows each client to access files from other clients in the network; and an ontology sharing system that allows each client to access ontology information from other clients in the network.

In a second aspect, the invention provides a client program stored on a recordable medium for providing peer-to-peer communications with other client programs within a computer network, wherein the client program comprises: an ontology sharing system that allows the client program to communicate directory structure information with other clients in the network.

In a third aspect, the invention provides a client program for providing peer-to-peer communications with other client programs within a computer network, wherein the client program comprises: means for sharing files with other client programs in the computer network; and means for sharing directory structure information with other client programs in the network.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a peer-to-peer client in accordance with the present invention.

FIG. 2 depicts an ontology sharing system in accordance with the present invention.

### DETAILED DESCRIPTION OF THE INVENTION

Overview

File system structures on personal computers comprise a large untapped source of information about ontologies. For instance, scientists share an ad hoc ontology by virtue of their shared pursuit of knowledge. They gather similar data and share similar papers, hence there tends to be some similarity in their file system organization. When these scientists, in the normal course of their file sharing, construct their shareable directory tree and place their files into this hierarchy, they provide ontological (or taxonomic) information both by the names they use for directories and by the files they place in them.

Each scientist organizes and thinks about the field a little differently. That organization is reflected in their file folder organization. Thus, each file can be found in a potentially different place on each machine (and perhaps in more than one place within a given scientist's directory structure). This information can be used to deduce ontologies. The name of the directory path to the folder in which a file resides contains information about how the scientist thinks about that file.

As noted above, peer-to-peer (P2P) networks have become a preferable mechanism for sharing files. Participants in a P2P network download a client that manages communication, search and file transfer between the various “peer machines” active in the network. Typically the user designates a “root directory” in the file system from which descends the directories of files they are willing to share, be searched, etc. Thus, to publish a document, the scientist merely places it somewhere in the shared directory tree. To search other scientist's work, a query is published which is forwarded from one participant to the next. The client software of each recipient of the query performs the requested search and returns the qualifying files. However, in previous systems, only files are shared, but not the file system structure. In the present invention, a file sharing system is provided that also shares the organizational or “ontology” information.

File systems in personal computers occupy the intersection of individual ontologies and the rigor required by computers. Scientists almost without exception use personal computers to store papers, presentations, data and results of analyses and many other types of information. They organize that information into the hierarchical file systems provided by virtually all computer operating systems, most notably WINDOWS™, MAC™, and all UNIX™ derivatives. Some of these file systems also allow virtual links that turn a hierarchy into a more general graph. The present invention exploits this ad hoc organizational behavior.

Peer-to-Peer Client Network

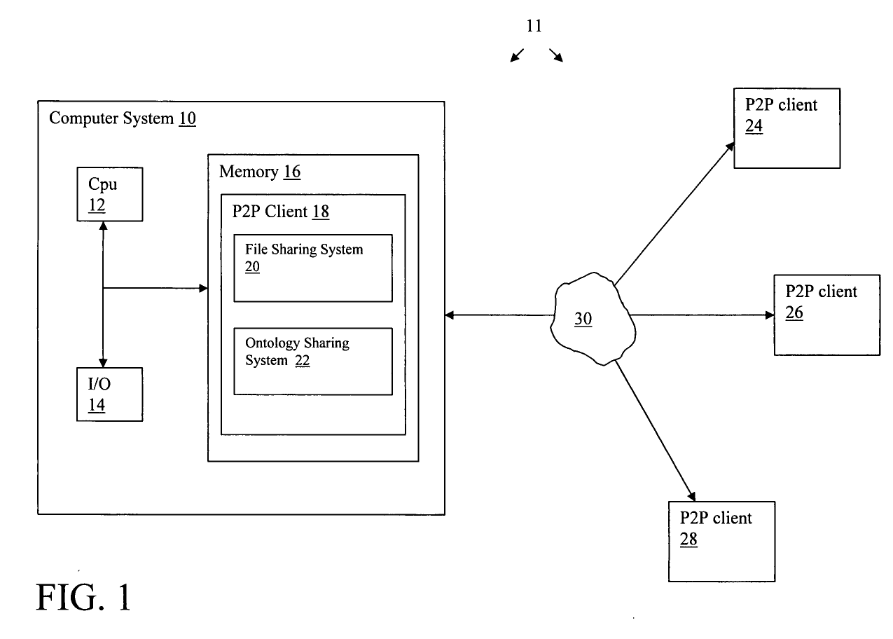

Referring now to the drawings, FIG. 1 depicts a peer-to-peer (P2P) network 11 in which P2P clients 18, 24, 26, 28 interact with each other over a network such as the World Wide Web 30. Each client may, for example, reside on a computer system 10 that includes, e.g., a CPU 12, I/O 14 and memory 16. CPU 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 12, memory 16 may reside at a single physical location, comprising one or more types of data storage, or be distributed across a plurality of physical systems in various forms. I/O 14 may comprise any system for exchanging information to/from an external source. Computer system 10 may also include external devices/resources such as audio capabilities, a CRT, LED screen, hand-held device, keyboard, mouse, voice recognition system, speech output system, printer, monitor/display, facsimile, pager, etc.

Communication between P2P clients may occur in any known manner. For example, communication could occur directly, or over a network such as the Internet, a local area network (LAN), a wide area network (WAN), a virtual private network (VPN), etc. In any event, communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity.

As shown, P2P client 18 includes a file sharing system 20 and ontology sharing system 22. File sharing system 20 may comprise any type of system for transferring files in a P2P network. Ontology sharing system 22 allows ontology information to be shared as well. For example, a participant in the P2P network 11 may store a paper entitled “Activation Energy for Incorporating Amino Acids” in a directory structure:
ROOT/DNA/coding/protein/protein biosynthesis/
   Because this directory structure may provide insightful information to the person searching for this information, ontology sharing system 22 transfers it along with the file.

Ontology information may be packaged in any format, e.g., an XML file. It should also be understood that while the present invention is described herein with references to bioinformatics applications, the invention could be applied to any information (e.g., music, history, geography, etc.) shared over a P2P network.

Ontology Sharing System

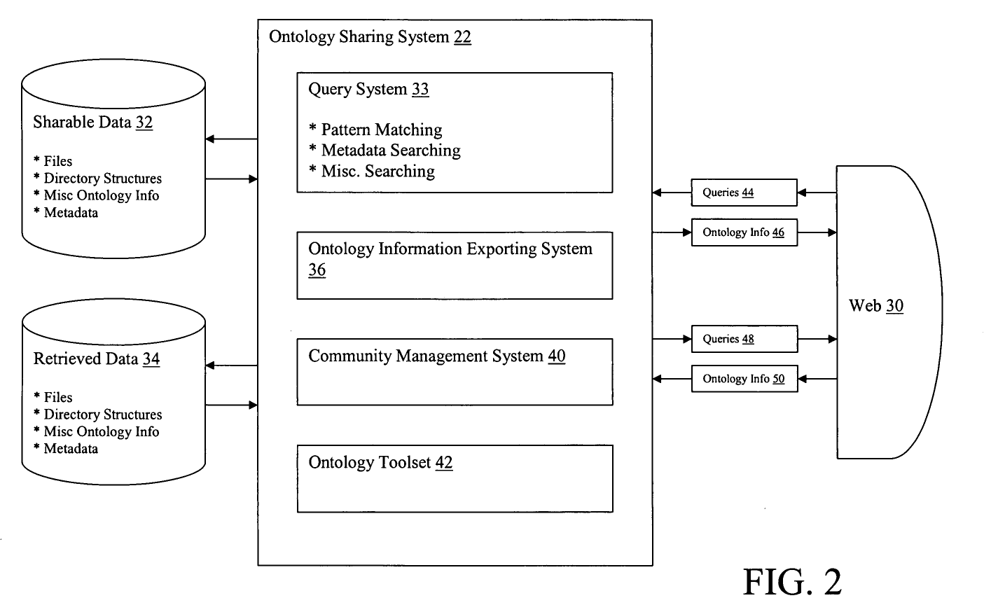

Referring now to FIG. 2, ontology sharing system 22 is described in further detail. In general, ontology sharing system 22 comprises two functional modes, which include: (1) receiving queries 44 from the P2P network and outputting ontology information 46 (i.e., a sharing mode); and (2) submitting queries 48 to the P2P network and receiving back ontology information 50 (i.e., a querying mode). The mechanisms for implementing both modes can be integrated with, or separately from, the file sharing system 20.

In the sharing mode, query system 33 accesses a database of sharable data 32 in response to queries from remote clients in the P2P network. Sharable data 32 may comprise, e.g., files, directory structures, miscellaneous ontology information such as community names, etc., and metadata. Sharable data 32 is shared with the P2P network via an ontology information exporting system 36. Ontology information exporting system 36 may comprise any type of system for packaging ontology data in a uniform format. For instance, when a remote client within the network requests a file from ontology sharing system 22, query system 33 will retrieve the path where the file resides, and hand it over to ontology information exporting system 36, which will then package the path information in a predetermined or requested format and transmit it back to the remote client with the requested file. The path information may include any information that could be of use, e.g., it may include a metadata file describing in more detail the path's role in the ontology.

Query system 33 may also comprise a pattern matching system that allows a remote client to search for particular word patterns that might exist in a directory structure. For instance, a user might want to search for a term such as “protein biosynthesis” or search for a hierarchy such as “DNA/coding.” The pattern matching system will thus supports search queries for hierarchies or partial hierarchies that fit a pattern, e.g., using a semantic-net searching technique. The pattern matching system may also support search queries for a path that contains a given file (e.g., a given gene, a given PubMed abstract, a given research paper, etc.). A scenario where this would be useful is where a researcher is interested in how other researchers categorize a publication authored by the researcher. The pathnames used by various people interested in a given paper are useful in helping the researcher understand how a work or gene sequence file is being used. Moreover, the pattern matching system may also support search queries for the path that contains files with given keywords, or that returns file names of all files in the same directory as a file that qualifies according to other search criteria.

Query system 33 may also include a mechanism for searching metadata, e.g., keywords, taxonomic assertions, etc., stored in sharable data 32. Metadata may be entered by the user or derived by mining/indexing features in the client. Metadata could be stored in the shareable-root directory to describe the whole tree, or be distributed into separate files, e.g., one per directory.

Query system 33 may also include a mechanism for searching for assertions about named ontological communities, thereby allowing the owner of the data to identify themselves within a community, e.g., “I belong to the structural protein researchers using NMR.” This feature would not only provide some guidance as to why a particular ontology is being used, but would also encourage the creation of named communities within which ontologies could converge more quickly. Community management system 40 is provided to link users to particular communities. Community management system 40 may also include means for promulgating proposed organizations. For example, it may send a message type comprising a tree or subtree to others as a proposed organization to be shared by those who wish to accept it. This elaboration creates a proactive path toward convergence of ontologies. That is especially true when a recognized leader in a given type of research sends out a proposed organization.

Community management system 40 may further include tools to share reorganization events. When the user adds to or modifies the directory structure anywhere under the root of the shared file structure, notifications of that event can be sent to those who have subscribed to such notifications so that others who may be attempting to share a common structure can adopt it or not.

In addition, ontology sharing system 22 may comprise an ontology toolset 42 that includes tools to help adapt directory structures (hence, ad hoc ontologies) amongst different users in the network. This involves systems for reorganizing and renaming shareable file systems to bring them closer to a chosen organization (presumably chosen as a result of ontological information about other's organizations). The consequence of such a system is that sub-communities can be formed that actually share an informal de facto ontology and their file systems can converge toward that de facto ontology. Also included may be tools to automatically reorganize a tree structure to fit a proposed reorganization, tools to choose all or part of a proposed reorganization, and instant messaging or “chat” tools to facilitate real-time debate about the merits of organizations.

The toolset may also include an application that could crawl the web to further deduce ontologies using, e.g., the following method: (1) start with one search and obtain the identities of machines that contain qualifying files; (2) find other files in the same directories; (3) do a “files similar to this” search finding other files in the same directories; and (4) iterate. This information can be used to create a visual web of directory structures gleaned from the search that shows how other scientists think about the contents of the data file.

When operating in the query mode, ontology sharing system 22 can output queries 48 and receive back ontology information, similar to that described above. The retrieved data 34 can later be made part of the sharable data, if desired. In one illustrative embodiment, ontology information received when a file is initially retrieved can be cached with the file. The cached information can then be passed along to requesters of the file as additional ontology information. This acknowledges that the present ontology may not be the same as that of the original provider of the file. Thus, a history of the ontologies is maintained. This historical information could speed the flow of ontological information since, in the process of retrieving one file, the user obtains perhaps many ontological paths.

Moreover, when a search finds more than one copy of a file, as will often be the case in P2P file sharing networks, the network can return only one copy of the file itself, but all paths in which the file was found. The result of this is similar to, but synergistic with, the previous elaboration.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product or propagated signal, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A peer-to-peer file sharing system that is implemented by a plurality of clients within a network, wherein each client includes:
a file sharing system that allows each client to access files from other clients in the network; and
an ontology sharing system that allows each client to access ontology information from other clients in the network.

2. The peer-to-peer file sharing system of claim 1, wherein the ontology information includes a directory structure identifying where a located file resides on a client computer.

3. The peer-to-peer file sharing system of claim 1, wherein the ontology information includes metadata that characterizes the ontology information.

4. The peer-to-peer file sharing system of claim 1, wherein the ontology information includes a community to which the client belongs.

5. The peer-to-peer file sharing system of claim 1, wherein the ontology sharing system includes a system for searching for word patterns in a directory structure.

6. The peer-to-peer file sharing system of claim 1, wherein the ontology sharing system includes a system for searching for ontology related metadata stored on a client computer.

7. The peer-to-peer file sharing system of claim 1, wherein the ontology sharing system includes a system for searching for community information on a client computer.

8. The peer-to-peer file sharing system of claim 1, wherein the ontology sharing system includes a system for reorganizing a file structure.

9. The peer-to-peer file sharing system of claim 1, wherein the ontology sharing system includes a system for promulgating proposed file structures to other clients in the network.

10. A client program stored on a recordable medium for providing peer-to-peer communications with other client programs within a computer network, wherein the client program comprises:
an ontology sharing system that allows the client program to communicate directory structure information with other clients in the network.

11. The client program of claim 10, wherein the directory structure information identifies a location of a file on a client computer.

12. The client program of claim 10, wherein the ontology sharing system allows the client program to communicate metadata that characterizes ontology information associated with the client program.

13. The client program of claim 10, wherein the ontology sharing system allows the client program to communicate a community to which a user of the client program belongs.

14. The client program of claim 10, wherein the ontology sharing system includes a system for searching for word patterns in a directory structure.

15. The client program of claim 10, wherein the ontology sharing system includes a system for searching for ontology related metadata stored on a client computer.

16. The client program of claim 10, wherein the ontology sharing system includes a system for searching for community information on a client computer.

17. The client program of claim 10, wherein the ontology sharing system includes a system for reorganizing a file structure.

18. The client program of claim 10, wherein the ontology sharing system includes a system for promulgating proposed file structures to other client programs in the network.

19. A client program for providing peer-to-peer communications with other client programs within a computer network, wherein the client program comprises:
means for sharing files with other client programs in the computer network; and
means for sharing directory structure information with other client programs in the network.

20. The client program of claim 19, wherein the directory structure information identifies a location of a file on a client computer.

21. The client program of claim 19, further comprising means for storing metadata that characterizes the directory structure information.

22. The client program of claim 19, further comprising means for identifying a community to which a user of the client program belongs.

23. The client program of claim 19, further comprising means for searching word patterns in a directory structure.

24. The client program of claim 19, further comprising means for searching ontology related metadata stored on a client computer.

25. The client program of claim 19, further comprising means for searching community information on a client computer.

26. The client program of claim 10, further comprising means for reorganizing a file structure.

27. The client program of claim 10, further comprising means for promulgating proposed file structures to other client programs in the network.

28. The client program of claim 10, further comprising means for storing historical ontology information with a file obtained from the computer network.
